(19) United States
(12) Patent Application Publication
(10) Pub. No.: US 2005/0114465 A1
(43) Pub. Date: May 26, 2005

(54) Apparatus and method to control access to logical volumes using one or more copy services

(75) Inventors: Juan A. Coronado, Tucson, AZ (US); Matthew J. Kalos, Tucson, AZ (US); Donald M. Nordahl, Tucson, AZ (US); Richard A. Ripberger, Tucson, AZ (US)

Correspondence Address: DALE F. REGELMAN, 4231 S. FREMONT AVENUE, TUCSON, AZ, 85714, US

(73) Assignee: International Business Machines Corporation

(21) Appl. No.: 10/719,487

(22) Filed: Nov. 20, 2003

(51) Int. Cl. G06F 15/167; G06F 15/177

(52) U.S. Cl. 709/214; 709/220

(57) ABSTRACT

A method to control access to logical volumes disposed in one or more information storage and retrieval systems when using copy service relationships. The method provides a first information storage and retrieval system, a second information storage and retrieval system, and a plurality of host computers capable of communicating with the first information storage and retrieval system. The method forms (N) host computer group, and assigns each of the plurality of host computers to the a host computer group. The method forms (N) logical volume groups, and assigns one or more of the plurality of first logical volumes to a logical volume group. The method receives a request from a host computer assigned to the (i)th host computer group to establish a copy service relationship between a source logical volume and a target logical volume. The method determines if both the source and target logical volumes are assigned to the (i)th logical volume group. If both the source and target logical volumes are assigned to the (i)th logical volume group, then the method establishes the requested copy service relationship.

### FIELD OF THE INVENTION

The invention relates to an apparatus and method to control access to logical volumes disposed in one or more information storage and retrieval systems when establishing, using, and/or terminating one or more copy service relationships comprising two or more of those logical volumes.

### BACKGROUND OF THE INVENTION

In hierarchical computer storage systems, fast and intensively used storage are paired with arrays of slower and less frequently accessed data devices. One example of high-speed, expensive memory is a direct access storage device file buffer (DASD). Slower storage devices include tape drives and disk drive arrays. Such tape drives and/or disk drive arrays are often located in an information storage and retrieval system, sometimes referred to as an automated media storage library.

Information storage and retrieval systems are known for providing cost effective access to large quantities of stored information, such as backup computer files. Generally, such information storage and retrieval systems include information storage media, such as a plurality of tape cartridges, a plurality of optical cartridges, a plurality of disk arrays, a plurality of electronic storage media, and the like. By electronic storage media, Applicants mean a device such as a PROM, EPROM, EEPROM, Flash PROM, and the like. A number of different companies manufacture automated media storage libraries today, each model displaying various different features. One example is the IBM TotalStorage® Enterprise Storage Server.

Storage area networks (SANs) are dedicated networks that connect one or more hosts or servers to storage devices and subsystems, such as an automated media library. SANs may utilize an appliance, such as a networked attached storage device (“NASD”) to provide for management of the SAN.

It is desirable to maintain copies of computer files, i.e. to maintain “backups.” In certain embodiments, files are copied to one or more logical volumes disposed in the same information storage and retrieval system. In other embodiments, files are copied to one or more logical volumes disposed in both a first information storage and retrieval system and in a second information storage and retrieval system, where the first storage system is geographically separated from the second storage system. Data disaster recovery solutions include various “peer-to-peer” copy routines where data is backed-up not only remotely, but also continuously (either synchronously or asynchronously).

What is needed is a method to control access to logical volumes disposed in one or more information storage and retrieval systems when establishing, maintaining, and/or terminating various copy service relationships between two or more of those logical volumes, where multiple host computers owned by differing persons have access rights to one or more of those logical volumes.

### SUMMARY OF THE INVENTION

Applicants' invention includes an apparatus and method to control access to logical volumes disposed in one or more information storage and retrieval systems when using copy service relationships. The method provides a first information storage and retrieval system comprising a plurality of first logical volumes, a second information storage and retrieval system comprising a plurality of second logical volumes, and a providing a plurality of host computers capable of communicating with the first information storage and retrieval system.

The method forms (N) host computer groups, and assigning each of the plurality of host computers to a host computer group. The method forms (N) logical volume groups, and assigns one or more of the plurality of first logical volumes to a logical volume group.

The method receives a request from a host computer assigned to the (i)th host computer group to establish a copy service relationship between a source logical volume and a target logical volume. The method determines if the source logical volume is assigned to the (i)th logical volume group. If the source logical volume is assigned to the (i)th logical volume group, then the method determines if the target logical volume is assigned to the (i)th logical volume group. If both the source and target logical volumes are assigned to the (i)th logical volume group, then the method establishes the requested copy service relationship.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing the components of one embodiment of Applicants' information storage and retrieval system;

FIG. 2 is a block diagram of Applicants' data processing system;

FIG. 3 is a flow chart summarizing the initial steps of Applicants' method;

FIG. 4 is a flow chart summarizing certain additional steps of Applicants' method;

FIG. 5 is a flow chart summarizing certain additional steps of Applicants' method.

### DETAILED DESCRIPTION OF THE PREFERRED EMBODIMENTS

Referring to the illustrations, like numerals correspond to like parts depicted in the Figures. The invention will be described as embodied in a data processing system.

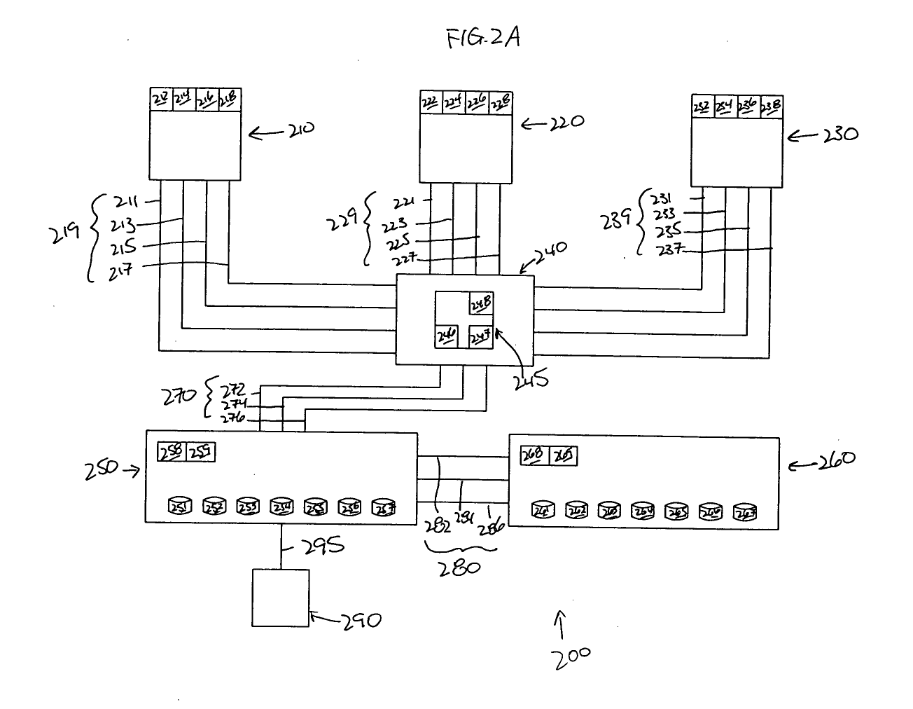

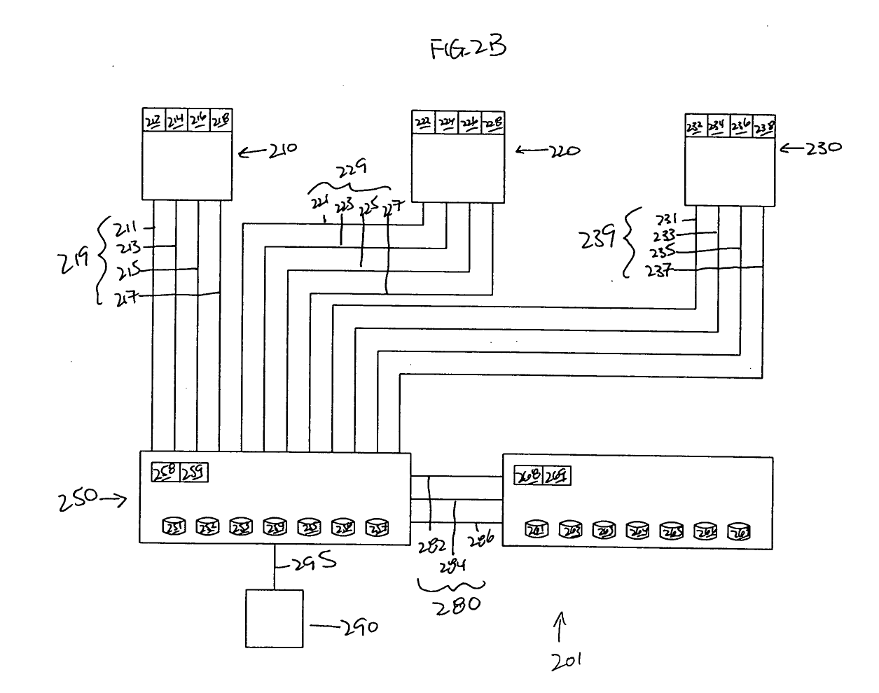

FIG. 2A shows one embodiment of Applicants' data processing system. In the illustrated embodiment of FIG. 2A, system 200 includes a first host computer 210, a second host computer 220, and a third host computer 230. Each of the first, second, and third host computers is interconnected with a storage area network (“SAN”) 240. SAN 240 is interconnected with information storage and retrieval system 250.

System 200 further includes configuration interface 290. In certain embodiments, configuration interface 290 is integral with information storage and retrieval system 250. In the illustrated embodiment of FIGS. 2A and 2B, configuration interface 290 is interconnected with information storage and retrieval system 250 by communication link 295. In certain embodiments, communication link 295 comprises the internet.

FIG. 2B shows another embodiment of Applicants' data processing system. In the illustrated embodiment of FIG. 2B, system 201 includes a first host computer 210, a second host computer 220, a third host computer 230, information storage and retrieval system 250, information storage and retrieval system 260, and configuration interface 290. Each of the first, second, and third host computers is interconnected with information storage and retrieval system 250.

The illustrated embodiments of FIGS. 2A and 2B include three host computers. In other embodiments, Applicants' data processing systems 200/201 include two host computers. In other embodiments, Applicants' data processing systems 200/201 include more than three host computers.

Host computer 210 comprises a computer system, such as a mainframes personal computer, workstation, and combinations thereof, including an operating system 212 such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) In certain embodiments, host computer 210 further includes a second operating system 218 such as, for example, Windows, AIX, Unix, MVS, LINUX, etc.

In certain embodiments, host computer 210 includes a storage management program 214. The storage management program 214 in the host computer 210 may include the functionality of storage management type programs known in the art that manage the transfer of data to a data storage and retrieval system, such as the IBM DFSMS implemented in the IBM MVS operating system.

Storage management program 214 may include known storage management program functions, such as recall and migration. The storage management program 214 may be implemented within the operating system 212 of the host computer 210 or as a separate, installed application program 216. Alternatively, storage management program 214 may include device drivers, backup software, application programs 216, and the like.

Host computer 220 comprises a computer system, such as a mainframe, personal computer, workstation, and combinations thereof, including an operating system 222 such as Windows, AIX, Unix, MVS, LINUX, etc. In certain embodiments, host computer 220 further includes a second operating system 228 such as, for example, Windows, AIX, Unix, MVS, LINUX, etc.

In certain embodiments, host computer 220 includes a storage management program 224. The storage management program 224 in the host computer 220 may include the functionality of storage management type programs known in the art that manage the transfer of data to a data storage and retrieval system, such as the IBM DFSMS implemented in the IBM MVS operating system.

Storage management program 224 may include known storage management program functions, such as recall and migration. The storage management program 224 may be implemented within the operating system 222 of the host computer 220 or as a separate, installed application program 226. Alternatively, storage management program 214 may include device drivers, backup software, application programs 226, and the like.

Host computer 230 comprises a computer system, such as a mainframe, personal computer, workstation, and combinations thereof, including an operating system 232 such as Windows, AIX, Unix, MVS, LINUX, etc. In certain embodiments, host computer 230 further includes a second operating system 238 such as, for example, Windows, AIX, Unix, MVS, LINUX, etc.

In certain embodiments, host computer 230 includes a storage management program 234. The storage management program 234 in the host computer 230 may include the functionality of storage management type programs known in the art that manage the transfer of data to a data storage and retrieval system, such as the IBM DFSMS implemented in the IBM MVS operating system.

Storage management program 234 may include known storage management program functions, such as recall and migration. The storage management program 234 may be implemented within the operating system 232 of the host computer 210 or as a separate, installed application program 236. Alternatively, storage management program 234 may include device drivers, backup software, application programs 236, and the like.

In the illustrated embodiment of FIG. 2A, host computer 210 is capable of communicating with SAN 240 via a plurality of communication links 219. In the illustrated embodiment of FIG. 2A, plurality of communication links 219 includes communication links 211, 213, 215, and 217. In other embodiments, host computer 210 is capable of communicating with SAN 240 via fewer than four communication links. In other embodiments, host computer 210 is capable of communicating with SAN 240 via more than four communication links. In certain embodiments, communication links 211, 213, 215, and 217, are each selected from the group consisting of a serial interconnection, such as RS-232 or RS-422, an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

In the illustrated embodiment of FIG. 2A, host computer 220 is capable of communicating with SAN 240 via a plurality of communication links 229. In the illustrated embodiment of FIG. 2A, plurality of communication links 229 includes communication links 221, 223, 225, and 227. In other embodiments, host computer 220 is capable of communicating with SAN 240 via fewer than four communication links. In other embodiments, host computer 220 is capable of communicating with SAN 240 via more than four communication links. In certain embodiments, communication links 221, 223, 225, and 227, are each selected from the group consisting of a serial interconnection, such as RS-232 or RS-422, an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

In the illustrated embodiment of FIG. 2A, host computer 230 is capable of communicating with SAN 240 via a plurality of communication links 239. In the illustrated embodiment of FIG. 2A, plurality of communication links 239 includes communication links 231, 233, 235, and 237. In other embodiments, host computer 230 is capable of communicating with SAN 240 via fewer than four communication links. In other embodiments, host computer 230 is capable of communicating with SAN 240 via more than four communication links. In certain embodiments, communication links 231, 233, 235, and 237, are each selected from the group consisting of a serial interconnection, such as RS-232 or RS-422, an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

SAN 240 comprises a storage area network, and includes NASD 245. NASD 245 includes controller 246 and memory 247.

SAN 240 is capable of communicating with information storage and retrieval system 250 via a plurality of communication links 270. In the illustrated embodiment of FIG. 2A, plurality of communication links 270 includes communication links 272, 274, and 276. In other embodiments, plurality of communication links 270 includes fewer than three communication links. In other embodiments, plurality of communication links 270 includes more than three communication links. In certain embodiments, communication links 272, 274, and 276, are each selected from the group consisting of an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

In the illustrated embodiment of FIG. 2B, host computer 210 is capable of communicating with information storage and retrieval system 250 via a plurality of communication links 219. In the illustrated embodiment of FIG. 2B, plurality of communication links 219 includes communication links 211, 213, 215, and 217. In other embodiments, host computer 210 is capable of communicating with information storage and retrieval system 250 via fewer than four communication links. In other embodiments, host computer 210 is capable of communicating with information storage and retrieval system 250 via more than four communication links. In certain embodiments, communication links 211, 213, 215, and 217, are each selected from the group consisting of an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

In the illustrated embodiment of FIG. 2B, host computer 220 is capable of communicating with information storage and retrieval system 250 via a plurality of communication links 229. In the illustrated embodiment of FIG. 2B, plurality of communication links 229 includes communication links 221, 223, 225, and 227. In other embodiments, host computer 210 is capable of communicating with information storage and retrieval system 250 via fewer than four communication links. In other embodiments, host computer 210 is capable of communicating with information storage and retrieval system 250 via more than four communication links. In certain embodiments, communication links 221, 223, 225, and 227, are each selected from the group consisting of an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

In the illustrated embodiment of FIG. 2B, host computer 230 is capable of communicating with information storage and retrieval system 250 via a plurality of communication links 239. In the illustrated embodiment of FIG. 2B, plurality of communication links 239 includes communication links 231, 233, 235, and 237. In other embodiments, host computer 210 is capable of communicating with information storage and retrieval system 250 via fewer than four communication links. In other embodiments, host computer 210 is capable of communicating with information storage and retrieval system 250 via more than four communication links. In certain embodiments, communication links 231, 233, 235, and 237, are each selected from the group consisting of an Ethernet interconnection, a SCSI interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, or other interconnections and/or protocols as is known to those of skill in the art.

In the illustrated embodiments of FIGS. 2A and 2B, information storage and retrieval system 250 is shown further including logical volumes 251, 252, 253, 254, 255, 256, and 257. In other embodiments, information storage and retrieval system 250 comprises more than seven logical volumes.

Information storage and retrieval system 260 includes controller 268 and non-volatile memory 269. In the illustrated embodiments of FIGS. 2A and 2B, information storage and retrieval system 260 is shown further including logical volumes 261, 262, 263, 264, 265, 266, and 267. In other embodiments, information storage and retrieval system 260 comprises more than seven logical volumes.

Information storage and retrieval system 250 is capable of communicating with information storage and retrieval system 260 via a plurality of communication links 280. In the illustrated embodiments of FIGS. 2A and 2B, plurality of communication links 280 includes communication links 282, 284, and 286. In other embodiments, plurality of communication links 280 includes fewer than three communication links. In other embodiments, plurality of communication links 280 includes more than three communication links.

In certain embodiments, the logical volumes disposed in Applicants' first and/or second information storage and retrieval system are written to one or more DASD device. In a certain embodiments, the logical volumes disposed in Applicants' first and/or second information storage and retrieval system are written to one or more hard disks. In certain embodiments, the logical volumes disposed in Applicants' first and/or second information storage and retrieval system are written to one or more hard disks, where those hard disks are configured in one or more hard disk arrays. In certain embodiments, the logical volumes disposed in Applicants' first and/or second information storage and retrieval system are written to one or more magnetic tapes.

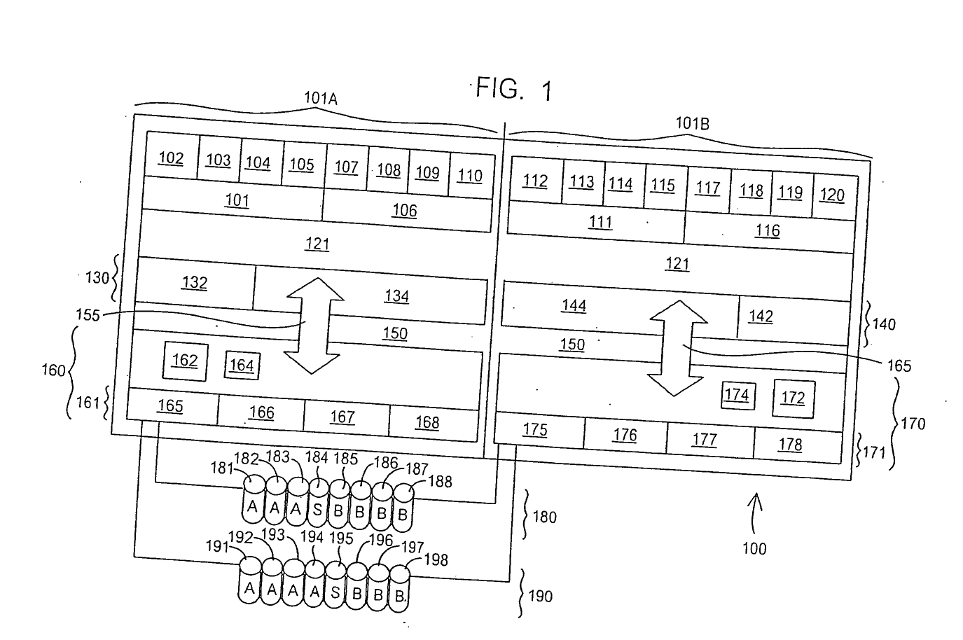

In certain embodiments, Applicants' first and/or second information storage and retrieval system 250 and/or 260, respectively, comprise an automated media library comprising a plurality of tape cartridges, one or more robotic accessors, and one or more tape drives. U.S. Pat. No. 5,970,030, assigned to the common assignee herein, describes such an automated media library and is hereby incorporated by reference. In certain embodiments, Applicants' first and/or second information storage and retrieval system 250 and/or 260, respectively, comprise a virtual tape system. U.S. Pat. No. 6,269,423, assigned to the common assignee herein, describes such a virtual tape system, and is hereby incorporated by reference. In certain embodiments, Applicants' first and/or second information storage and retrieval system 250 and/or 260, respectively, comprise information storage and retrieval system 100 (FIG. 1).

Referring now to FIG. 1, Applicants' information storage and retrieval system 100 includes a first cluster 101A and a second cluster 101B. Each cluster includes a processor portion 130/140 and an input/output portion 160/170. Internal PCI buses in each cluster are connected via a Remote I/O bridge 155/165 between the processor portions 130/140 and I/O portions 160/170, respectively.

Information storage and retrieval system 100 further includes a plurality of host adapters 102-105, 107-110, 112-115, and 117-120, disposed in four host bays 101, 106, 111, and 116. Each host adapter may comprise one or more Fibre Channel ports, FICON ports, ESCON ports, or SCSI ports. Other embodiments may have host adapters comprising ports supporting other protocols known to those skilled in the art. Each host adapter is connected to both clusters through one or more Common Platform Interconnect buses 121 and 150 such that each cluster can handle I/O from any host adapter.

Processor portion 130 includes processor 132 and cache 134. Processor portion 140 includes processor 142 and cache 144. I/O portion 160 includes non-volatile storage (“NVS”) 162 and NVS batteries 164. I/O portion 170 includes NVS 172 and NVS batteries 174.

I/O portion 160 further comprises a plurality of device adapters, such as device adapters 165, 166, 167, and 168, and sixteen disk drives organized into two disk arrays, namely array “A” and array “B”. In certain embodiments, hard disk arrays “A” and “B” utilize a RAID protocol. As those skilled in the art will appreciate, a RAID (Redundant Array of Independent Disks) rank combines multiple inexpensive disk drives into an array of disk drives to obtain performance, capacity and reliability that exceeds that of a single large drive.

In certain embodiments, arrays “A” and “B” comprise what is sometimes called a JBOD array, i.e. “Just a Bunch Of Disks” where the array is not configured according to RAID. The illustrated embodiment of FIG. 1 shows two hard disk arrays. In other embodiments, Applicants' information storage and retrieval system includes more than two hard disk arrays.

Hard disk array “A” includes disk drives 181, 182, 183, 184, 191, 192, and 193. Hard disk array “B” includes disk drives 185, 186, 187, 188, 195, 196, 197, and 198. In the illustrated embodiment of FIG. 1, each loop includes at least two spare disks, namely disks 184 and 195. Each of the hard disk arrays includes one of those spare disks.

Referring again to FIGS. 2A and 2B, in certain embodiments, host computer 210 is owned by a first person. In certain embodiments, host computer 220 is owned by a second person. In certain embodiments, host computer 230 is owned by a third person. In certain embodiments, two or more of the first person, the second person, and/or the third person, differ. As those skilled in the art will appreciate, it is desirable to limit access by, for example, the first person to only logical volumes comprising information owned by that first person. Similarly, it is desirable to limit access by the second person and by the third person to logical volumes comprising information owned by that second person or third person, respectively.

In certain embodiments, the storage system which includes information storage and retrieval system 250, information storage and retrieval system 260, configuration interface 290, and optionally one or more storage area networks, such as storage area network 240, is owned by a fourth person. In certain embodiments, that fourth person differs from the first person, the second person, and/or the third person. In order to limit the access by the first person, and/or the second person, and/or the third person, to some but not all the logical volumes disposed in information storage and retrieval system 250, the fourth person must implement an apparatus and method to control access to the logical volumes disposed in information storage and retrieval system 250.

Applicants' invention includes a method to control access to logical volumes disposed in one or more information storage and retrieval systems when establishing, using, and/or terminating, one or more copy service relationships comprising one or more of the logical volumes disposed in a first information storage and retrieval system, such as information storage and retrieval system 250, and/or one or more logical volumes disposed in a second information storage and retrieval system 260.

In certain embodiments, the first logical volume and the second logical volume are both disposed in Applicants' first information storage and retrieval system. In these embodiments, the available copy service relationships include a FlashCopy relationship or a Concurrent Copy relationship.

In certain embodiments, a first logical volume, i.e. a source logical volume, is disposed in Applicants' first information storage and retrieval system, and a second logical volume, i.e. the target logical volume, is disposed in Applicants' second information storage and retrieval system. In these embodiments, the available copy service relationships include a remote FlashCopy relationship, a peer-to-peer remote copy (“PPRC”) relationship, or an extended remote copy (“XRC”) relationship.

Applicants' FlashCopy copy service provides a point-in-time copy of all or a portion of a logical volume, sometimes referred to as a T₀ copy, with almost instant availability for the host computer of both the source and target volumes. As soon as a FlashCopy establish command relationship is issued, Applicants' information storage and retrieval system, such as information storage and retrieval system 250, establishes a FlashCopy relationship between the target volume, such as for example volume 254 (FIG. 2), and the source volume, such as volume 252 (FIG. 2). During this establish of the FlashCopy relationship, a metadata structure is created for the relationship. This metadata is used by Applicants' information storage and retrieval system to map source and target volumes as they were at the T₀ time, as well as to manage subsequent reads and updates to the source and target volumes. The establish process takes a minimum amount of time. As soon as the relationship is established, user programs, such as user program 216, that have access rights to the source and target volumes have access to both the source and target copies of the data.

During a subsequent background copy operation, destaging algorithms manage the copy process. Applicants' information storage and retrieval system, using the metadata structure created during the establish, keeps track of which data has been copied from the source logical volume to the target logical volume, and manages the integrity of both copies.

In certain embodiments, a FlashCopy session exists from the time the FlashCopy relationship is established until all the designated data has been copied from the source volume to the target volume. In other embodiments, the FlashCopy service relationship exists until expressly terminated.

Applicants' Concurrent Copy service provides a point-in-time copy of data concurrent with normal application processing, In certain embodiments, Applicants' Concurrent Copy service utilizes System Data Mover (“SDM”) algorithms disposed in IBM's DFSMS program, such as program 214 (FIG. 2).

Using a Concurrent Copy relationship, Applicants' method generates a copy or a dump of data while an application, such as for example, application 216 (FIG. 2) is updating that data. Concurrent Copy works not only on a full-volume basis, but also at a data set level. In addition, the target logical volume is not restricted to volumes in the same information storage and retrieval system. Rather, the source volume, such as logical volume 253 (FIG. 2) may be disposed in a DASD in a first information storage and retrieval system, and the target volume, such as for example logical volume 263 (FIG. 2), may be disposed on a magnetic tape disposed in a second information storage and retrieval system.

A Concurrent Copy session comprises a single invocation of a Concurrent Copy relationship. A session may include one or more data sets or volumes, on the same information storage and retrieval system or across different information storage and retrieval system. Applicants' information storage and retrieval system, such as information storage and retrieval system 250, assigns a unique session ID to each Concurrent Copy session. Applicants' storage system uses this session ID to identify and coordinate all host and storage system resources associated with a particular Concurrent Copy session.

When an application, such as for example application 226 (FIG. 2), tries to update information that is included in a Concurrent Copy domain, Applicants' storage system intercepts those writes, thus maintaining a copy of the data as it was at the time the Concurrent Copy relationship was established. During processing of an intercepted write, Applicants' storage system copies a before-image of the track being updated into a sidefile for later processing. The storage system and the SDM maintain two sidefiles, one in Applicants' information storage and retrieval system and another in the requesting host computer. The Concurrent Copy relationship terminates when DFSMS has copied the Concurrent Copy domain and both the sidefiles are empty.

Applicants' Extended Remote Copy (“XRC”) service utilizes the SDM described above, where that copy service maintains a copy of data asynchronously at a remote location, and can be implemented over unlimited distances. XRC will copy primary volumes from a primary storage site to secondary volumes at the secondary storage site. The primary volume and its corresponding secondary volume makes an XRC volume pair.

Applicants' peer-to-peer remote copy (“PPRC”) service enables the mirroring of information disposed in a primary site, such as information storage and retrieval system 250 (FIG. 2), to a secondary site, such as information storage and retrieval system 260 (FIG. 2). Updates made to the primary site are synchronously or asynchronously shadowed onto the secondary logical volumes.

IBM publication SG24-5680-02, entitled IBM TotalStorage ENTERPRISE STORAGE SERVER IMPLEMENTING ESS COPY SERVICES WITH IBM eSERVER zSERIES, September 2003, describes Applicants' FlashCopy copy service, remote FlashCopy copy service, various PPRC copy services, and XRC service, and is hereby incorporated by reference.

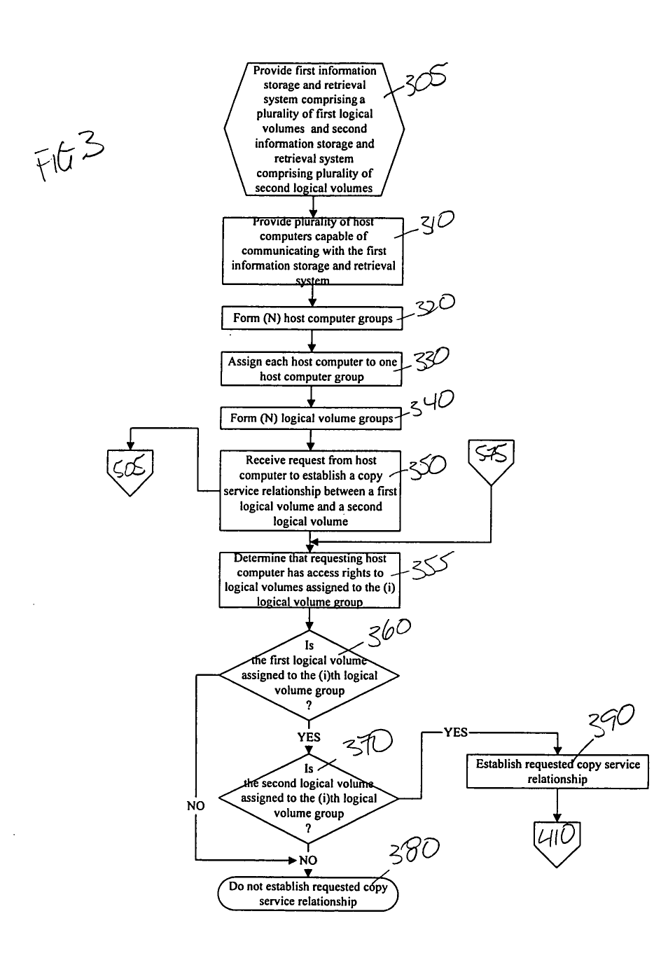

Applicants' invention includes a method to control access to logical volumes disposed in one or more information storage and retrieval system when establishing, using, or terminating one or more copy service relationships comprising two or more of those logical volumes. FIG. 3 summarizes the initial steps of Applicants' method. Referring now to FIG. 3, in step 305 Applicants' method provides a first information storage and retrieval system, such as system 250 (FIG. 2), where that information storage and retrieval system includes a plurality of logical volumes, such as plurality of logical volumes 251-257 (FIG. 2), where that first information storage and retrieval system is capable of communicating with a second information storage and retrieval system, such as information storage and retrieval system 260 (FIG. 2), comprising a plurality of logical volumes, such as logical volumes 261-267 (FIG. 2).

In step 310, Applicant's method provides a plurality of host computers, such as host computers 210, 220, 230, where each of those host computers are capable of communicating with Applicants' first information storage and retrieval system.

In step 320, Applicant's method forms (N) host computer groups, where (N) is equal to or greater than 1. In certain embodiments, one or more of those host computer groups includes one host computer. In certain embodiments, one or more of those host computer groups includes two or more host computers. In certain embodiments, step 320 is performed by a storage system owner and/or operator, such as the owner and/or operator of information storage and retrieval system 250 (FIG. 2). In certain embodiments, step 320 is performed by a controller, such as controller 258, disposed in Applicants' information storage and retrieval system.

In step 330, Applicants' method assigns each host computer capable of communicating with the first information storage and retrieval system to one of the (N) host computer groups, such that an assigned host computer is only assigned to one of the (N) host computer groups. In certain embodiments, step 330 is performed by a storage system owner and/or operator, such as the owner and/or operator of information storage and retrieval system 250 (FIG. 2). In certain embodiments, step 330 is performed by a controller, such as controller 258, disposed in Applicants' information storage and retrieval system.

In step 340, Applicants' method forms (N) logical volume groups, such that a logical volume is only assigned, if at all, to one of those (N) logical volume groups. Using Applicants' method, a host computer assigned to the (i)th host computer group has access rights to logical volumes assigned to the (i)th logical volume group. In certain embodiments, step 340 is performed by a storage system owner and/or operator, such as the owner and/or operator of information storage and retrieval system 250 (FIG. 2). In certain embodiments, step 340 is performed by a controller, such as controller 258, disposed in Applicants' information storage and retrieval system.

In step 350, Applicants' storage system receives a request from a host computer to establish a copy service relationship between a first logical volume, i.e. a source volume, and a second logical volume, i.e. a target volume. In certain embodiments, the first logical volume and the second logical volume are both disposed in one first information storage and retrieval system. In these embodiments, the copy service relationship requested in step 350 may comprise a FlashCopy relationship or a Concurrent Copy relationship.

In certain embodiments, the first logical volume is disposed in a first information storage and retrieval system, such as information storage and retrieval system 250 (FIG. 2), and the second logical volume is disposed in a second information storage and retrieval system, such as information storage and retrieval system 260 (FIG. 2). In these embodiments, the copy service relationship requested in step 350 may comprise a remote FlashCopy relationship, a peer-to-peer remote copy (“PPRC”) relationship, or an extended remote copy (“XRC”) relationship.

In step 355, Applicants' method determines that the requesting host computer is assigned to the (i)th host computer group. In certain embodiments, step 360 is performed by a controller, such as controller 258, disposed in Applicants' information storage and retrieval system. In certain embodiments, step 360 is performed by a controller, such as controller 242 (FIG. 2) disposed in an NASD, such as NASD 245. Therefore, the requesting host computer has access rights to logical volumes assigned to the (i)th logical volume group.

In step 360, Applicants' method determines if the first logical volume, i.e. the source volume, is assigned to the (i)th logical volume group. In certain embodiments, step 360 is performed by a controller, such as controller 258, disposed in Applicants' information storage and retrieval system. In certain embodiments, step 360 is performed by a controller, such as controller 242 (FIG. 2) disposed in an NASD, such as NASD 245.

If Applicant' method determines that the first logical volume is not assigned to the (i)th logical volume, then the method transitions from step 360 to step 380 wherein the method does not establish the requested copy services relationship. Alternatively, if Applicants' method determines that the first logical volume is assigned to the (i)th logical volume, then the method transitions from step 360 to step 370 wherein the method determines if the second logical volume is assigned to the (i)th logical volume group. In certain embodiments, step 370 is performed by a controller, such as controller 258, disposed in Applicants' information storage and retrieval system. In certain embodiments, step 370 is performed by a controller, such as controller 242 (FIG. 2) disposed in an NASD, such as NASD 245.

If Applicants' method determines in step 370 that the second logical volume is not assigned to the (i)th logical volume group, then the method transitions from step 370 to step 380 wherein the method denies the request to establish the copy service relationship of step 350 and ends. In certain embodiments, step 380 is performed by a controller, such as controller 258, disposed in Applicants' information storage and retrieval system. In certain embodiments, step 380 is performed by a controller, such as controller 242 (FIG. 2) disposed in an NASD, such as NASD 245.

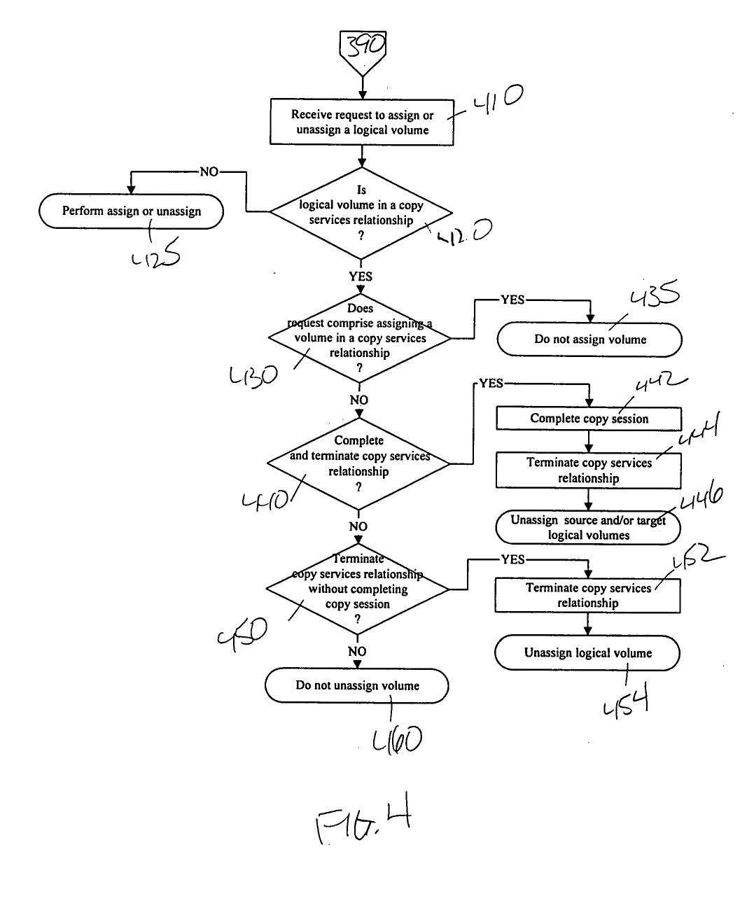

Alternatively, if Applicants' method determines in step 370 that the second logical volume is assigned to the (i)th logical volume group, then the method transitions from step 370 to step 390 wherein the method established the requested copy services relationship. In certain embodiments, step 390 is performed by a controller, such as controller 258, disposed in Applicants' information storage and retrieval system. In certain embodiments, step 390 is performed by a controller, such as controller 242 (FIG. 2) disposed in an NASD, such as NASD 245. Applicants' method transitions from step 390 to step 410 (FIG. 4).

For example, if both the source volume and the target volume are assigned to the (i)th logical volume group, then the (i)th host computer group has access rights to both the source volume and the target volume, and in step 390 Applicants' method establishes the requested copy services relationship. Alternatively, if the source volume is assigned to the (i)th logical volume group, and the target volume is assigned to the (j)th logical volume group, where (i) does not equal (j), then Applicants' method denies the request to establish a copy services relationship between the source and target volumes.

FIG. 4 recites the steps of Applicants' method relating to requests to change the configuration of a volume in an established copy services relationship. Referring now to FIG. 4, in step 410 Applicants' storage system receives a request to assign or to unassign a logical volume disposed in one of Applicants' information storage and retrieval systems. In step 420, Applicants' method determines if the logical volume of step 410 is in a copy service relationship. In certain embodiments, step 420 is performed by a controller, such as controller 258, disposed in Applicants' information storage and retrieval system. In certain embodiments, step 420 is performed by a controller, such as controller 242 (FIG. 2) disposed in an NASD, such as NASD 245.

If Applicants' method determines in step 420 that the logical volume designated in the request of step 410 is not in a copy services relationship, then the method transitions from step 420 to step 425 wherein the method performs the requested assign or unassign. In certain embodiments, step 425 is performed by a controller, such as controller 258, disposed in Applicants' information storage and retrieval system. In certain embodiments, step 425 is performed by a controller, such as controller 242 (FIG. 2) disposed in an NASD, such as NASD 245.

If Applicants' method determines in step 420 that the logical volume designated in the request of step 410 is in a copy services relationship, then the method transitions from step 420 to step 430 wherein method determines if the request of step 410 includes assigning a logical volume in a copy services relationship. In certain embodiments, step 430 is performed by a controller, such as controller 258, disposed in Applicants' information storage and retrieval system. In certain embodiments, step 430 is performed by a controller, such as controller 242 (FIG. 2) disposed in an NASD, such as NASD 245.

If Applicants' method determines in step 430 that the request of step 410 comprises assigning a logical volume in an established copy service relationship, then the method transitions from step 430 to step 435 wherein the method denies the request to assign the logical volume. In certain embodiments, step 435 is performed by a controller, such as controller 258, disposed in Applicants' information storage and retrieval system. In certain embodiments, step 435 is performed by a controller, such as controller 242 (FIG. 2) disposed in an NASD, such as NASD 245.

If the logical volume designated in the request of step 410 is in a copy services relationship, and if that request does not comprise assigning that logical volume, then the request of step 410 comprises unassigning a logical volume in a copy services relationship. If Applicants' method determines in step 430 that the request of step 410 does not comprise assigning a logical volume in a copy services relationship, then the method transitions from step 430 to step 440 wherein the method determines whether to complete and terminate the copy services relationship before unassigning the designated logical volume. In certain embodiments, step 440 is performed by a controller, such as controller 258, disposed in Applicants' information storage and retrieval system. In certain embodiments, step 440 is performed by a controller, such as controller 242 (FIG. 2) disposed in an NASD, such as NASD 245.

If Applicants' method determines in step 440 to complete and terminate the copy services relationship before unassigning the designated logical volume, then the method transitions from step 440 to step 442 wherein the method completes the copy session comprising the requested copy services relationship of step 350 (FIG. 3). In certain embodiments, step 442 is performed by a controller, such as controller 258, disposed in Applicants' information storage and retrieval system. In certain embodiments, step 442 is performed by a controller, such as controller 242 (FIG. 2) disposed in an NASD, such as NASD 245.

Applicants' method transitions from step 442 to step 444 wherein the method terminates the copy service relationship established in step 390 (FIG. 3). In certain embodiments, step 444 is performed by a controller, such as controller 258, disposed in Applicants' information storage and retrieval system. In certain embodiments, step 444 is performed by a controller, such as controller 242 (FIG. 2) disposed in an NASD, such as NASD 245.

Applicants' method transitions from step 444 to step 446 wherein the method unassigns the logical volume designated in the request of step 410. In certain embodiments, step 446 is performed by a controller, such as controller 258, disposed in Applicants' information storage and retrieval system. In certain embodiments, step 446 is performed by a controller, such as controller 242 (FIG. 2) disposed in an NASD, such as NASD 245.

If Applicants' method determines in step 440 not to complete and terminate the copy services relationship before unassigning the logical volume designated in step 410, then the method transitions from step 440 to step 450 wherein the method determines whether to terminate the copy services relationship before completing the copy session.

If Applicants' method determines in step 450 not to terminate the copy services relationship before completing the copy session, then the method transitions from step 450 to step 460 wherein the method does not unassign the volume(s) recited in the request of step 410. If Applicants' method determines in step 450 to terminate the copy services relationship before completing the copy session, then the method transitions from step 450 to step 452 wherein the method terminates the copy services relationship even if the copy session is not completed. Depending on the copy service established in step 390, terminating that relationship before completing the copy session implementing that copy service could result in data loss. Therefore, in certain embodiments step 452 must be performed by the storage system owner/operator.

Applicants' method transitions from step 452 to step 454 wherein the method unassigns the source volume and/or the target volume. In certain embodiments, step 454 is performed by a controller, such as controller 258, disposed in Applicants' information storage and retrieval system. In certain embodiments, step 454 is performed by a controller, such as controller 242 (FIG. 2) disposed in an NASD, such as NASD 245.

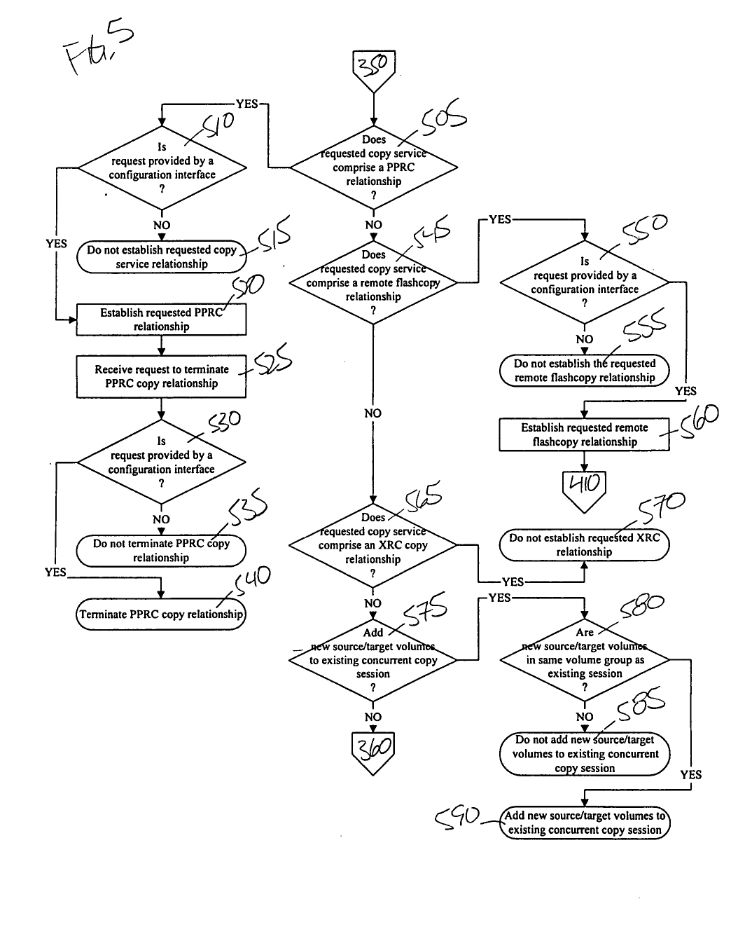

In certain embodiments, Applicants' method transitions from step 350 (FIG. 3) to step 505 (FIG. 5). Referring now to FIG. 5, in step 505 Applicants' method determines if the requested copy service of step 350 (FIG. 3) comprises a PPRC copy service. By “PPRC copy service,” Applicants' mean any PPRC copy service described in Publication No. SG24-5680-02, i.e. Peer-to-Peer Remote Copy Version 1 (Chapter 2), Peer-to-Peer Remote Copy Version 2 (Chapter 4), or Peer-to-Peer Remote Copy Extended Distance (Chapter 3). In certain embodiments, step 505 is performed by a controller, such as controller 258, disposed in Applicants' information storage and retrieval system. In certain embodiments, step 505 is performed by a controller, such as controller 242 (FIG. 2) disposed in an NASD, such as NASD 245.

If Applicants' method determines in step 505 that the requested copy service of step 350 (FIG. 3) comprises a PPRC copy service, then the method transitions from step 505 to step 510 wherein the method determines if the request of step 350 was provided by a configuration interface, such as configuration interface 290. In certain embodiments, step 510 is performed by a controller, such as controller 258, disposed in Applicants' information storage and retrieval system.

Only the storage system owner/operator can access configuration interface 290. Therefore, a request to establish a copy services relationship between a first logical volume disposed in a first information storage and retrieval system and a second logical volume disposed in a second information storage and retrieval system provided by a configuration interface is necessarily provided by the storage system owner/operator. Prior to making such a request, the storage system owner/operator will verify that host computers having access rights to the first logical volume also have access rights to the second logical volume.

If Applicants' method determines in step 510 that the request of step 350 to establish a PPRC copy service relationship was not provided by a configuration interface, then Applicants' method transitions from step 510 to step 515 wherein the method denies the request of step 350. In certain embodiments, step 515 is performed by a controller, such as controller 258, disposed in Applicants' information storage and retrieval system. In certain embodiments, step 515 is performed by a controller, such as controller 242 (FIG. 2) disposed in an NASD, such as NASD 245.

Alternatively, if Applicants' method determines in step 510 that the request of step 350 to establish a PPRC copy service relationship was provided by a configuration interface, then Applicants' method transitions from step 510 to step 520 wherein the method establishes the requested PPRC copy service relationship. In certain embodiments, step 520 is performed by a controller, such as controller 258, disposed in Applicants' information storage and retrieval system. In certain embodiments, step 520 is performed by a controller, such as controller 242 (FIG. 2) disposed in an NASD, such as NASD 245.

In certain embodiments, Applicants' method in step 525 receives a request to terminate the PPRC relationship established in step 520. Applicants' method transitions from step 525 to step 530 wherein the method determines if the request to terminate a PPRC relationship in step 525 was provided by a configuration interface. In certain embodiments, step 530 is performed by a controller, such as controller 258, disposed in Applicants' information storage and retrieval system. In certain embodiments, step 530 is performed by a controller, such as controller 242 (FIG. 2) disposed in an NASD, such as NASD 245.

If Applicants' method determines in step 530 that the request of step 525 to terminate a PPRC copy service relationship established in step 520 was not provided by a configuration interface, then Applicants' method transitions from step 530 to step 535 wherein the method denies the request of step 525. In certain embodiments, step 535 is performed by a controller, such as controller 258, disposed in Applicants' information storage and retrieval system. In certain embodiments, step 535 is performed by a controller, such as controller 242 (FIG. 2) disposed in an NASD, such as NASD 245.

Alternatively, if Applicants' method determines in step 530 that the request of step 325 to terminate a PPRC copy service relationship was provided by a configuration interface, then Applicants' method transitions from step 530 to step 540 wherein the method terminates the PPRC copy service relationship established in step 520. In certain embodiments, step 540 is performed by a controller, such as controller 258, disposed in Applicants' information storage and retrieval system. In certain embodiments, step 540 is performed by a controller, such as controller 242 (FIG. 2) disposed in an NASD, such as NASD 245.

If Applicant' method determines in step 505 that the requested copy service relationship of step 350 (FIG. 3) does not include a PPRC copy service relationship, then the method transitions from step 505 to step 545 wherein the method determines if the requested copy service relationship comprises a remote FlashCopy service relationship. In certain embodiments, step 545 is performed by a controller, such as controller 258, disposed in Applicants' information storage and retrieval system. In certain embodiments, step 545 is performed by a controller, such as controller 242 (FIG. 2) disposed in an NASD, such as NASD 245.

If Applicants' method determines in step 545 that the requested copy service relationship comprises a remote FlashCopy service relationship, then the method transitions from step 545 to step 550 wherein the method determines if the request of step 350 to establish a remote FlashCopy service relationship was provided by a configuration interface. In certain embodiments, step 550 is performed by a controller, such as controller 258, disposed in Applicants' information storage and retrieval system. In certain embodiments, step 550 is performed by a controller, such as controller 242 (FIG. 2) disposed in an NASD, such as NASD 245.

Therefore, if Applicants' method determines in step 550 that the request of step 350 to establish a remote FlashCopy service relationship was not provided by a configuration interface, then Applicants' method transitions from step 550 to step 555 wherein the method denies the request of step 350 and ends. In certain embodiments, step 555 is performed by a controller, such as controller 258, disposed in Applicants' information storage and retrieval system. In certain embodiments, step 555 is performed by a controller, such as controller 242 (FIG. 2) disposed in an NASD, such as NASD 245.

Alternatively, if Applicants' method determines in step 550 that the request of step 350 to establish a FlashCopy service relationship was provided by a configuration interface, then Applicants' method transitions from step 550 to step 560 wherein the method establishes the requested remote FlashCopy service relationship. In certain embodiments, step 560 is performed by a controller, such as controller 258, disposed in Applicants' information storage and retrieval system. In certain embodiments, step 560 is performed by a controller, such as controller 242 (FIG. 2) disposed in an NASD, such as NASD 245.

If Applicants' method determines in step 545 that the requested copy service relationship of step 350 (FIG. 3) does not include a remote FlashCopy service relationship, then the method transitions from step 545 to step 565 wherein the method determines if the requested copy service relationship comprises an XRC service relationship. In certain embodiments, step 565 is performed by a controller, such as controller 258, disposed in Applicants' information storage and retrieval system. In certain embodiments, step 565 is performed by a controller, such as controller 242 (FIG. 2) disposed in an NASD, such as NASD 245.

If Applicants' method determines in step 565 that the requested copy service relationship comprises an XRC service relationship, then the method transitions from step 565 to step 570 wherein the method denies the request of step 350 to establish an XRC service relationship. In certain embodiments, step 570 is performed by a controller, such as controller 258, disposed in Applicants' information storage and retrieval system. In certain embodiments, step 570 is performed by a controller, such as controller 242 (FIG. 2) disposed in an NASD, such as NASD 245.

If Applicants' method determines in step 565 that the requested copy service relationship does not comprises an XRC service relationship, then the method transitions from step 565 to step 575 wherein the method determines if the request of step 350 includes adding new source and/or new target volumes to an existing Concurrent Copy session. In certain embodiments, step 575 is performed by a controller, such as controller 258, disposed in Applicants' information storage and retrieval system. In certain embodiments, step 575 is performed by a controller, such as controller 242 (FIG. 2) disposed in an NASD, such as NASD 245.

If Applicants' method determines in step 575 that the request of step 350 includes adding new source and/or new target volumes to an existing Concurrent Copy session, then the method transitions from step 575 to step 580 wherein the method determines if the new source volumes and if the new target volumes are assigned to the same logical volume group as the source/target volumes in the existing Concurrent Copy session. In certain embodiments, step 580 is performed by a controller, such as controller 258, disposed in Applicants' information storage and retrieval system. In certain embodiments, step 580 is performed by a controller, such as controller 242 (FIG. 2) disposed in an NASD, such as NASD 245.

If Applicants' method determines in step 580 that the one or more new source volumes and/or the one or more new target volumes are assigned to the same logical volume group as the source/target volumes in the existing Concurrent Copy session, then the method transitions from step 580 to step 590 wherein the method adds the new source volumes and/or new target volumes to the existing Concurrent Copy session. In certain embodiments, step 590 is performed by a controller, such as controller 258, disposed in Applicants' information storage and retrieval system. In certain embodiments, step 590 is performed by a controller, such as controller 242 (FIG. 2) disposed in an NASD, such as NASD 245.

If Applicants' method determines in step 580 that the one or more new source volumes and/or the one or more new target volumes are not assigned to the same logical volume group as the source/target volumes in the existing Concurrent Copy session, then the method transitions from step 580 to step 585 wherein the method denies the request to add the new source volumes and/or new target volumes to the existing Concurrent Copy session. In certain embodiments, step 585 is performed by a controller, such as controller 258, disposed in Applicants' information storage and retrieval system. In certain embodiments, step 585 is performed by a controller, such as controller 242 (FIG. 2) disposed in an NASD, such as NASD 245.

If Applicants' method determines in step 575 that the request of step 350 does not include adding one or more new source volumes, and/or adding one or more new target volumes, to an existing Concurrent Copy session, then Applicants' method transitions from step 575 to step 360 and continues.

The embodiments of Applicants' method recited in FIGS. 3, 4, and/or 5, may be implemented separately. Moreover, in certain embodiments, individual steps recited in FIGS. 3, 4, and/or 5, may be combined, eliminated, or reordered.

In certain embodiments, Applicants' invention includes instructions residing in non-volatile memory 259 (FIG. 2), or in nonvolatile memory 247 (FIG. 2), where those instructions are executed by controller 258 (FIG. 2), or controller 246, respectively, to performs steps 320, 330, 340, 350, 360, 370, 380, and 390, recited in FIG. 3, steps 410 through 460 recited in FIG. 4, and/or steps 505 through 590 recited in FIG. 5. In other embodiments, Applicants' invention includes instructions residing in any other computer program product, where those instructions are executed by a computer external to, or internal to, system 200, to perform steps 320, 330, 340, 350, 360, 370, 380, and 390, recited in FIG. 3, steps 410 through 460 recited in FIG. 4, and/or steps 505 through 590 recited in FIG. 5. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

1. A method to control access to logical volumes disposed in one or more information storage and retrieval systems using copy service relationships, comprising the steps of:
providing a first information storage and retrieval system comprising a plurality of first logical volumes;
providing a second information storage and retrieval system comprising a plurality of second logical volumes;
providing a plurality of host computers, wherein each of said plurality of host computers is capable of communicating with said first information storage and retrieval system;
forming (N) host computer groups, wherein (N) is greater than or equal to 1;
assigning each of said plurality of host computers to the a host computer group;
forming (N) logical volume groups;
assigning one or more of said plurality of first logical volumes to a logical volume group;
receiving a request from a host computer assigned to the (i)th host computer group to establish a copy service relationship between a source logical volume and a target logical volume, wherein (i) is greater than or equal to 1 and less than or equal to (N);
determining if said source logical volume is assigned to the (i)th logical volume group;
operative if said target logical volume is assigned to the (i)th logical volume group, determining if said second logical volume is assigned to the (i)th logical volume group;
operative if both the source logical volume and the target logical volume are assigned to the (i)th logical volume group, establishing said copy service relationship.

2. The method of claim 1, further comprising the steps of:
receiving a request to revise access rights to one or more of said plurality of first logical volumes or one or more of said plurality of second logical volumes;
determining if said request comprises assigning to one of said (N) logical volume groups a logical volume in a copy relationship;
operative if said request comprises assigning to one of said (N) logical volume groups a logical volume in a copy relationship, denying said request.

3. The method of claim 1, further comprising the steps of:
receiving a request to revise access rights to one or more of said plurality of first logical volumes;
determining if said request comprises unassigning one of said first logical volumes in a copy relationship;
operative if said request comprises unassigning one of said first logical volumes in a copy service relationship, wherein said copy service relationship comprises a copy session, determining whether to complete said copy session and then terminate the copy service relationship;
operative if said request comprises unassigning one of said first logical volumes in a copy service relationship and if said copy session is to be completed prior to terminating said copy service relationship:
completing said copy session;
terminating said copy service relationship; and
unassiging said one of said first logical volumes.

4. The method of claim 3, further comprising the steps of:
operative if said request comprises unassigning one of said first logical volumes but does not comprise un assigning one of said first logical volumes in a copy service relationship, unassigning said one of said first logical volumes;
operative if said request comprises unassigning one of said first logical volumes in a copy service relationship and if said copy service relationship is not to be terminated, denying the request to unassign said one of said first logical volumes;
operative if said copy session will not be completed prior to terminating said copy service relationship:
terminating said copy service relationship prior to completing said copy session; and
unassigning said one of said first logical volumes.

5. The method of claim 1, further comprising the steps of:
providing a configuration interface interconnected to said first information storage and retrieval system;
determining if said copy service relationship comprises a PPRC relationship;
operative if said copy service relationship comprises a PPRC relationship, determining if said request was provided by said configuration interface;
operative if said request was provided by said configuration interface, establishing the requested PPRC relationship;
operative if said request was not provided by said configuration interface, not establishing the requested PPRC relationship.

6. The method of claim 5, further comprising the steps of:
receiving a termination request to terminate said PPRC relationship;
determining if said termination request was provided by said configuration interface;
operative if said termination request was provided by said configuration interface, terminating the PPRC relationship;
operative if said termination request was not provided by said configuration interface, denying the request to terminate the PPRC relationship.

7. The method of claim 1, further comprising the steps of:
determining if said requested copy service relationship comprises an XRC relationship;
operative if said requested copy service relationship comprises an XRC relationship, denying said request to establish said XRC relationship.

8. The method of claim 1, further comprising the steps of:
providing a configuration interface interconnected with said first information storage and retrieval system;
determining if said requested copy service relationship comprises a remote FlashCopy relationship;
operative if said copy service relationship comprises a remote FlashCopy relationship, determining if said request was provided by said configuration interface;
operative if said request was provided by said configuration interface, establishing the requested remote FlashCopy relationship;
operative if said request was not provided by said configuration interface, denying the request to establish a remote FlashCopy relationship.

9. The method of claim 1, further comprising the steps of:
determining if said requested copy service relationship comprises adding a new source logical volume and/or a new target logical volume to an existing Concurrent Copy session comprising an existing logical volume group;
operative if said requested copy service relationship comprises adding a new source logical volume or a new target logical volume to an existing Concurrent Copy session, determining if said new source logical volume and/or said new target logical volume are assigned to said existing logical volume group;
operative if said new source logical volume and/or said new target logical volume are assigned to said existing logical volume group, adding said new source logical volume and/or said new target logical volume to said existing Concurrent Copy session.

10. The method of claim 9, further comprising the step of operative if said new source logical volume and/or said new target logical volume are not assigned to said existing logical volume group, not adding said new source logical volume and/or said new target logical volume to said existing Concurrent Copy session

11. An article of manufacture comprising a computer useable medium having computer readable program code disposed therein to control access to one or more logical volumes disposed in a first information storage and retrieval system and/or in a second information storage and retrieval system using a copy service relationship, wherein a plurality of host computers are capable of communicating with said first information storage and retrieval system, the computer readable program code comprising a series of computer readable program steps to effect:
forming (N) host computer groups, wherein (N) is greater than or equal to 1;
assigning each of said plurality of host computers to the a host computer group;
forming (N) logical volume groups;
assigning one or more of said plurality of first logical volumes to a logical volume group;
receiving a request from a host computer assigned to the (i)th host computer group to establish a copy service relationship between a source logical volume and a target logical volume, wherein (i) is greater than or equal to 1 and less than or equal to (N);
determining if said source logical volume is assigned to the (i)th logical volume group;
operative if said target logical volume is assigned to the (i)th logical volume group, determining if said second logical volume is assigned to the (i)th logical volume group;
operative if both the source logical volume and the target logical volume are assigned to the (i)th logical volume group, establishing said copy service relationship.

12. The article of manufacture of claim 11, said computer readable program code further comprising a series of computer readable program steps to effect:
receiving a request to revise access rights to one or more of said plurality of first logical volumes;
determining if said request comprises assigning to one of said (N) logical volume groups a logical volume in a copy relationship;
operative if said request comprises assigning to one of said (N) logical volume groups a logical volume in a copy relationship, denying said request.

13. The article of manufacture of claim 11, said computer readable program code further comprising a series of computer readable program steps to effect:
receiving a request to revise access rights to one or more of said plurality of first logical volumes;
determining if said request comprises unassigning one of said first logical volumes, wherein said one of said first logical volumes is in a copy relationship;
operative if said request comprises unassigning one of said first logical volumes in a copy service relationship, wherein said copy service relationship comprises a copy session, determining whether to complete said copy session and then terminate the copy service relationship;
operative if said request comprises unassigning one of said first logical volumes in a copy relationship and if said copy session is to be completed prior to terminating said service relationship:
completing said copy session;
terminating said copy service relationship; and
unassiging said one of said first logical volumes logical volume.

14. The article of manufacture of claim 13, said computer readable program code further comprising a series of computer readable program steps to effect:
operative if said request comprises unassigning one of said first logical volumes but does not comprise unassigning one of said first logical volumes in a copy service relationship, unassigning said one of said first logical volumes;
operative if said request comprises unassigning one of said first logical volumes in a copy service relationship and if said copy service relationship is not to be terminated, denying the request to unassign said one of said first logical volumes;
operative if said copy session will not be completed prior to terminating said copy service relationship:
terminating said copy service relationship prior to completing said copy session; and
unassigning said one of said first logical volumes.

15. The article of manufacture of claim 11, wherein said article of manufacture is capable of communicating with a configuration interface, said computer readable program code further comprising a series of computer readable program steps to effect:
determining if said copy service relationship comprises a PPRC relationship;
operative if said copy service relationship comprises a PPRC relationship, determining if said request was provided by said configuration interface;
operative if said request was provided by said configuration interface, establishing the requested PPRC relationship;
operative if said request was not provided by said configuration interface, not establishing the requested PPRC relationship.

16. The article of manufacture of claim 15, said computer readable program code further comprising a series of computer readable program steps to effect:
receiving a termination request to terminate said PPRC relationship;
determining if said termination request was provided by said configuration interface;
operative if said termination request was provided by said configuration interface, terminating the PPRC relationship;
operative if said termination request was not provided by said configuration interface, denying the request to terminate the PPRC relationship.

17. The article of manufacture of claim 11, said computer readable program code further comprising a series of computer readable program steps to effect:
determining if said requested copy service relationship comprises an XRC relationship;
operative if said requested copy service relationship comprises an XRC relationship, denying said request to establish said XRC relationship.

18. The article of manufacture of claim 11, wherein said article of manufacture is capable of communicating with a configuration interface, said computer readable program code further comprising a series of computer readable program steps to effect:
determining if said requested copy service relationship comprises a remote FlashCopy relationship;
operative if said copy service relationship comprises a remote FlashCopy relationship, determining if said request was provided by said configuration interface;
operative if said request was provided by said configuration interface, establishing the requested remote FlashCopy relationship;
operative if said request was not provided by said configuration interface, denying the request to establish a remote FlashCopy relationship.

19. The article of manufacture of claim 11, said computer readable program code further comprising a series of computer readable program steps to effect:
determining if said requested copy service relationship comprises adding a new source logical volume and/or a new target logical volume to an existing Concurrent Copy session comprising an existing logical volume group;
operative if said requested copy service relationship comprises adding a new source logical volume or a new target logical volume to an existing Concurrent Copy session, determining if said new source logical volume and/or said new target logical volume are assigned to said existing logical volume group;
operative if said new source logical volume and/or said new target logical volume are assigned to said existing logical volume group, adding said new source logical volume and/or said new target logical volume to said existing Concurrent Copy session.

20. The article of manufacture of claim 19, said computer readable program code further comprising a series of computer readable program steps to effect operative if said new source logical volume and/or said new target logical volume are not assigned to said existing logical volume group, not adding said new source logical volume and/or said new target logical volume to said existing Concurrent Copy session.

21. A computer program product usable with a programmable computer processor having computer readable program code embodied therein to control access to one or more logical volumes disposed in a first information storage and retrieval system comprising a plurality of first logical volumes and/or in a second information storage and retrieval system comprising a plurality of second logical volumes, wherein a plurality of host computers are capable of communicating with said first information storage and retrieval system, comprising:
computer readable program code which causes said programmable computer processor to form (N) host computer groups, wherein (N) is greater than or equal to 1;
computer readable program code which causes said programmable computer processor to assign each of said plurality of host computers to a host computer group;
computer readable program code which causes said programmable computer processor to form (N) logical volume groups;
computer readable program code which causes said programmable computer processor to assign one or more of said plurality of first logical volumes to a logical volume group;
computer readable program code which causes said programmable computer processor to receive a request from a host computer assigned to the (i)th host computer group to establish a copy service relationship between a source logical volume and a target logical volume, wherein (i) is greater than or equal to 1 and less than or equal to (N);
computer readable program code which causes said programmable computer processor to determine if said source logical volume is assigned to the (i)th logical volume group;
computer readable program code which, if said source logical volume is assigned to the (i)th logical volume group, causes said programmable computer processor to determine if said target logical volume is assigned to the (i)th logical volume group;
computer readable program code which, if both the source logical volume and the target logical volume are assigned to the (i)th logical volume group, causes said programmable computer processor to establish said copy service relationship.

22. The computer program product of claim 21, further comprising:
computer readable program code which causes said programmable computer processor to receive a request to revise access rights to one or more of said plurality of first logical volumes;
computer readable program code which causes said programmable computer processor to determine if said request comprises assigning to one of said (N) logical volume groups a logical volume in a copy relationship;
computer readable program code which, if said request comprises assigning to one of said (N) logical volume groups a logical volume in a copy relationship, causes said programmable computer processor to deny said request.

23. The computer program product of claim 21, further comprising:
computer readable program code which causes said programmable computer processor to receive a request to revise access rights to one or more of said plurality of first logical volumes;
computer readable program code which causes said programmable computer processor to determine if said request comprises unassigning one of said first logical volumes, wherein said one of said first logical volumes is in a copy relationship;
computer readable program code which, if said request comprises unassigning one of said first logical volumes in a copy service relationship wherein said copy service relationship comprises a copy session, causes said programmable computer processor to determine whether to complete said copy session and then terminate the copy service relationship;
computer readable program code which, if said request comprises unassigning one of said first logical volumes in a copy relationship and if said copy session is to be completed prior to terminating said service relationship, causes said programmable computer processor to complete said copy session, and then terminate said copy service relationship, and then unassign said one of said first logical volumes logical volume.

24. The computer program product of claim 23, further comprising:
computer readable program code which, if said request comprises unassigning one of said first logical volumes but does not comprise unassigning one of said first logical volumes in a copy service relationship, causes said programmable computer processor to unassign said one of said first logical volumes;
computer readable program code which, if said request comprises unassiging one of said first logical volumes in a copy service relationship and if said copy service relationship is not to be terminated, causes said programmable computer processor to deny the request to unassign said one of said first logical volumes;
computer readable program code which, if said copy session will not be completed prior to terminating said copy service relationship causes said programmable computer processor to terminate said copy service relationship prior to completing said copy session, and then unassign said one of said first logical volumes.

25. The computer program product of claim 21, wherein said first information storage and retrieval system is capable of communicating with a configuration interface, further comprising:
computer readable program code which causes said programmable computer processor to determine if said copy service relationship comprises a PPRC relationship;
computer readable program code which, if said copy service relationship comprises a PPRC relationship, causes said programmable computer processor to determine if said request was provided by said configuration interface;
computer readable program code which, if said request was provided by said configuration interface, causes said programmable computer processor to establish the requested PPRC relationship;
computer readable program code which, if said request was not provided by said configuration interface, causes said programmable computer processor to deny said request to establish the requested PPRC relationship.

26. The computer program product of claim 25, further comprising:
computer readable program code which causes said programmable computer processor to receive a termination request to terminate said PPRC relationship;
computer readable program code which causes said programmable computer processor to determine if said termination request was provided by said configuration interface;
computer readable program code which, if said termination request was provided by said configuration interface, causes said programmable computer processor to terminate the PPRC relationship;
computer readable program code which, if said termination request was not provided by said configuration interface, causes said programmable computer processor to deny the request to terminate the PPRC relationship.

27. The computer program product of claim 21, further comprising:
computer readable program code which causes said programmable computer processor to determine if said requested copy service relationship comprises an XRC relationship;
computer readable program code which, if said requested copy service relationship comprises an XRC relationship, causes said programmable computer processor to deny said request to establish said XRC relationship.

28. The computer program product of claim 21, wherein said first information storage and retrieval system is capable of communicating with a configuration interface, further comprising:
computer readable program code which causes said programmable computer processor to determine if said requested copy service relationship comprises a remote FlashCopy relationship;
computer readable program code which, if said copy service relationship comprises a remote FlashCopy relationship, causes said programmable computer processor to determine if said request was provided by said configuration interface;
computer readable program code which, if said request was provided by said configuration interface, causes said programmable computer processor to establish the requested remote FlashCopy relationship;
computer readable program code which, if said request was not provided by said configuration interface, causes said programmable computer processor to deny the request to establish a remote FlashCopy relationship.

29. The computer program product of claim 21, further comprising:
computer readable program code which causes said programmable computer processor to determine if said requested copy service relationship comprises adding a new source logical volume and/or a new target logical volume to an existing Concurrent Copy session comprising an existing logical volume group;
computer readable program code which, if said requested copy service relationship comprises adding a new source logical volume or a new target logical volume to an existing Concurrent Copy session, causes said programmable computer processor to determine if said new source logical volume and/or said new target logical volume are assigned to said existing logical volume group;
computer readable program code which, if said new source logical volume and/or said new target logical volume are assigned to said existing logical volume group, causes said programmable computer processor to add said new source logical volume and/or said new target logical volume to said existing Concurrent Copy session.

30. The computer program product of claim 29, further comprising computer readable program code which, if said new source logical volume and/or said new target logical volume are not assigned to said existing logical volume group, causes said programmable computer processor to deny the request to add said new source logical volume and/or said new target logical volume to said existing Concurrent Copy session.
